(19) United States
(12) Patent Application Publication
(10) Pub. No.: US 2008/0132323 A1
(43) Pub. Date: Jun. 5, 2008

(54) System for arranging gaming machines in a restricted space

(76) Inventor: Matt Paul O'Hara, Mangerton (AU)

Correspondence Address: LADAS & PARRY LLP, 26 WEST 61ST STREET, NEW YORK, NY, 10023, US

(21) Appl. No.: 11/982,717

(22) Filed: Nov. 2, 2007

(30) Foreign Application Priority Data
Nov. 3, 2006 (AU) 2006906145

(51) Int. Cl. A63F 9/24; G06F 9/44

(52) U.S. Cl. 463/20; 717/106

(57) ABSTRACT

A method of arranging a group of adjacent gaming machines in a restricted space is disclosed, each said machine being, at a point of closest approach, a distance of one metre or less from a neighbouring machine in the group. The method comprises specifying (1001) the number of gaming machines in the group, specifying (1003) a sub-set of the machines to be ordinary machines, specifying (1005) the remainder of the machines to be hot machines wherein the number of hot machines in the group exceeds a predetermined number, and arranging (1007) the plurality of gaming machines so that in regard to hot machines in the group, a said hot machine lacks an immediately neighbouring machine on at least one side

### COPYRIGHT NOTICE

This patent specification contains material that is subject to copyright protection. The copyright owner has no objection to the reproduction of this patent specification or related materials from associated patent office files for the purposes of review, but otherwise reserves all copyright whatsoever.

### FIELD OF THE INVENTION

The present invention relates generally to gaming machines, and in particular, to a method of arranging gaming machines in gaming rooms, and to the arrangements flowing from use of the method. The term gaming machine in this specification refers particularly to slot machines and poker machines.

### BACKGROUND

The gaming industry as it relates to use of gaming machines in clubs and casinos is highly competitive. Profits depend significantly on the extent to which club patrons use the gaming machines. A distinct but related factor is the efficient utilisation of the restricted space allocated to gaming rooms. Groups of gaming machines are thus generally arranged in gaming rooms in a manner that maximises the number of machines in the restricted space in the room.

FIG. 1 shows a gaming machine 704 and a prior art arrangement of a group 705 of gaming machines. The gaming machine 104 has an interface 703, whose orientation is defined by an axis of symmetry 714, in front of which a player 702 typically sits. The centre point of the machine at the player interface is depicted by a point 719 (also referred to as “B” in relation to FIG. 17). The centre point at the back of the machine is depicted by point 118 (also referred to as “A” in relation to FIG. 17). These points 718 and 719 are used to position the machine as described in relation to FIG. 17.

The interface 703 generally comprises a display and a number of controls that the layer 702 can manipulate in order to operate the gaming machine 704. The group 705 of gaming machines shows two rows 709, 710 of gaming machines arranged in a back-to-back manner, in which game machines 706, 707 and 708 are arranged in a back-to-back manner with respective gaming machines 711, 712 and 713.

Although FIG. 1 depicts the game machines in the group 705 as being in contact with each other, in fact the gaming machines may be somewhat spaced apart from each other as depicted by a group 715. The spacing between machines, as depicted by 716 and 717, is typically less than 1 metre.

FIG. 2 shows a prior art arrangement 800 of how groups of gaming machines 802-805, and 808-811 are typically arranged in the restricted space afforded by a gaming room 801. The groups 802-805, and 808-811 of gaming machines are arranged in the back-to-back manner shown at 705 in FIG. 1. The number of gag machines in each group is determined by the width 807 of the room 801, taking into account the passages at the ends of the groups necessary to allow for free movement of patrons. The number of groups of gaming machines in the room 801 is determined by the breadth 806 of the room 801, taking into account the passages at the edges of the room 801 and between the groups of gaming machines necessary to allow for free movement of patrons. Although FIG. 2 shows a rectangular room, gaming machines are typically arranged using the described back-to-back group approach, irrespective of the shape of the room, in a manner that maximises the number of machines in the restricted space in the room.

### SUMMARY

It is an object of the present invention to provide an alternate method for arranging gaming machines in the restricted space of a gaming room, by increasing the relative number of “hot positions” in the room at the possible expense of some reduction in the number of machines in the room relative to conventional arrangements. The disclosed method for arranging the gaming machines is referred to as the Hot Position Method (ie HPM), and arrangements of gaming machines arranged according to the HPM method are referred to as HPM arrangements. All gaming machines in a group of gaming machines according to the disclosed HPM arrangements must satisfy the criterion that the minimum distance between a machine in the group and the closest part of an adjacent machine in the to group must be one meter or less. Furthermore, in relation to machines in hot positions (also referred to as hot machines), either (a) the axis of symmetry of a machine in a hot position in the group must be angularly displaced from the axis of symmetry of an adjacent machine in the group by more than 20 degrees, and/or (b) the machine in a hot position must be positioned in such a way that a player at the machine in the hot position lacks an immediate neighbour on at least one side. Machines other than the hot machines in the group are referred to as “ordinary machines” or equivalently as machines in ordinary positions.

According to one aspect of the present invention, there is provided a method of arranging a group of adjacent gaming machines in a restricted space, each said machine being, at a point of closest approach, a distance of one metre or less from a neighboring machine in the group, the method comprising the steps of:

specifying the number of gaming machines in the group;

specifying a sub-set of the machines to be ordinary machines;

specifying the remainder of the machines to be hot machines wherein the number of hot machines in the group exceeds a predetermined number; and

arranging the plurality of gaming machines so that in regard to hot machines in the group, at least one of the following criteria are met:
a said hot machine lacks an immediately neighbouring machine on at least one side; and
a player at a hot machine does not have an immediate neighbouring player on at least one side.

According to another aspect of the present invention, there is provided an apparatus for arranging a group of adjacent gaming machines in a restricted space, each said machine being, at a point of closest approach, a distance of one metre or less from a neighbouring machine in the group, said apparatus comprising:

a memory for storing a program; and

a processor for executing the program, said program comprising:

code for specifying the number of gaming machines in the group;

code for specifying a sub-set of the machines to be ordinary machines;

code for specifying the remainder of the machines to be hot machines wherein the number of hot machines in the group exceeds a predetermined number; and

code for arranging the plurality of gaming machines so that in regard to hot machines in the group, at least one of the following criteria are met:
a said hot machine lacks an immediately neighbouring machine on at least one side; and
a player at a hot machine does not have an immediate neighbouring player on at least one side.

According to another aspect of the present invention, there is provided a computer program product including a computer readable medium having recorded thereon a computer program for directing a processor to execute a method for arranging a group of adjacent gaming machines in a restricted space, each said machine being, at a point of closest approach, a distance of one metre or less from a neighbouring machine in the group, said program comprising:

code for specifying the number of gaming machines in the group;

code for specifying a sub-set of the machines to be ordinary machines;

code for specifying the remainder of the machines to be hot machines wherein the Dumber of hot machines in the group exceeds a predetermined number; and

code for arranging the plurality of gaming machines so that in regard to hot machines in the group, at least one of the following criteria are met:
a said hot machine lacks an immediately neighbouring machine on at least one side; and
a player at a hot machine does not have an immediate neighbouring player on at least one side.

According to another aspect of the present invention, there is provided an arrangement of a group of adjacent gaming machines in a restricted space, wherein:

adjacent gaming machines in the group are, at their point of closest approach, at a distance of one metre or less;

a sub-set of the machines are ordinary machines;

the remainder of the machines are hot machines;

the number of hot machines in the group is greater than a predetermined number; and wherein in regard to hot machines in the group, at least one of the following criteria are met:
a said hot machine lacks an immediately neighbouring machine on at least one side; and
a player at a hot machine does not have an immediate neighbouring player on at least one side.

Other aspects of the invention are also disclosed.

### BRIEF DESCRIPTION OF THE DRAWINGS

Some aspects of the prior art and one or more embodiments of the present invention will now be described with reference to the drawings and appendices, in which:

FIG. 1 shows a gaming machine and a prior art arrangement of a group of gaming machines;

FIG. 2 shows a prior art arrangement of how groups of gaming machines are typically arranged in the restricted space afforded by a gaming room;

FIG. 3 depicts “ordinary” machines and machines in hot positions in a group of gaming machines;

FIG. 4 depicts the minimum angular displacement between the axis of symmetry of a machine in a hot position in the group and the axis of symmetry of a machine in an adjacent position in the group;

FIG. 5 shows a flow chart of an example of the HPM method for arranging a group of gaming machines;

FIGS. 6-12 depict examples of HPM arrangements;

FIG. 13 shows a flow chart of how the arranging step in FIG. 5 can be performed;

FIG. 14 is a schematic block diagram of a general-purpose computer upon which HPM arrangements can be practiced;

FIGS. 15-16 show further examples of HPM arrangements;

FIG. 17 illustrates how the information in APPENDIX A can be used to position machines in a group; and

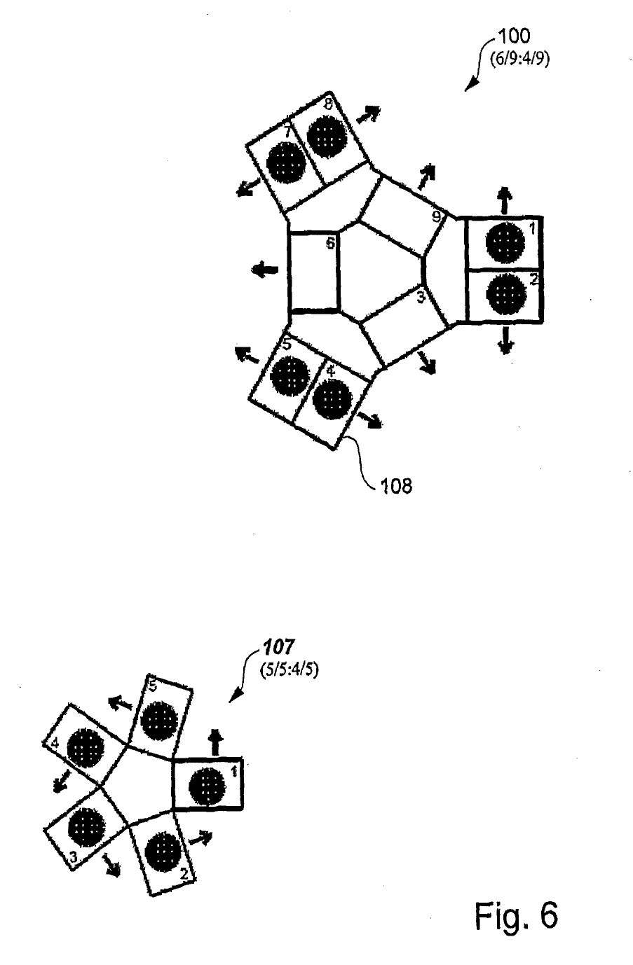

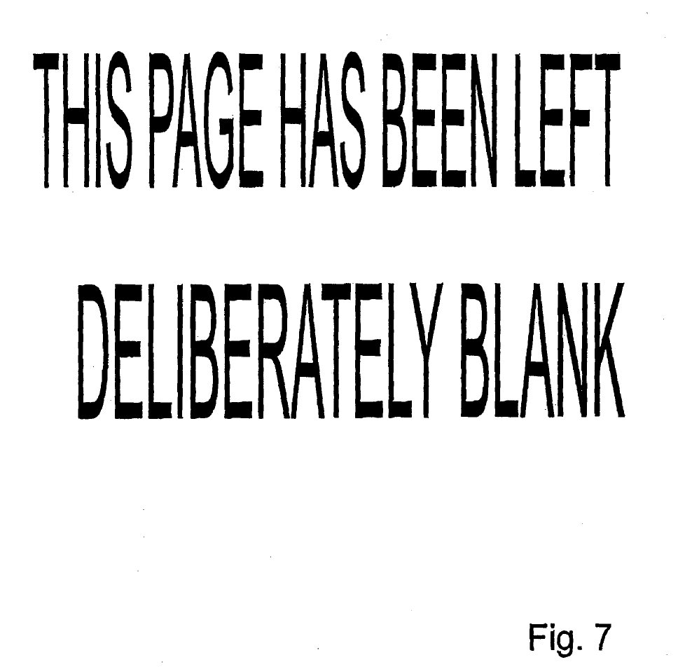

APPENDIX A contains a table which presents information defining the relative locations and orientations of gaming machines in some of the arrangements of FIGS. 6-12 and FIGS. 15-16.

### DETAILED DESCRIPTION INCLUDING BEST MODE

Where reference is made in any one or more of the accompanying drawings to steps and/or features, which have the same reference numerals, those steps and/or features have for the purposes of his description the same function(s) or operation(s), unless the contrary intention appears.

It is to be noted that the discussions contained in the “Background” section relating to prior art arrangements relate to arrangements which form public knowledge through their use. Such discussions should not be interpreted as a representation that such arrangements in any way form part of the common general knowledge in the art.

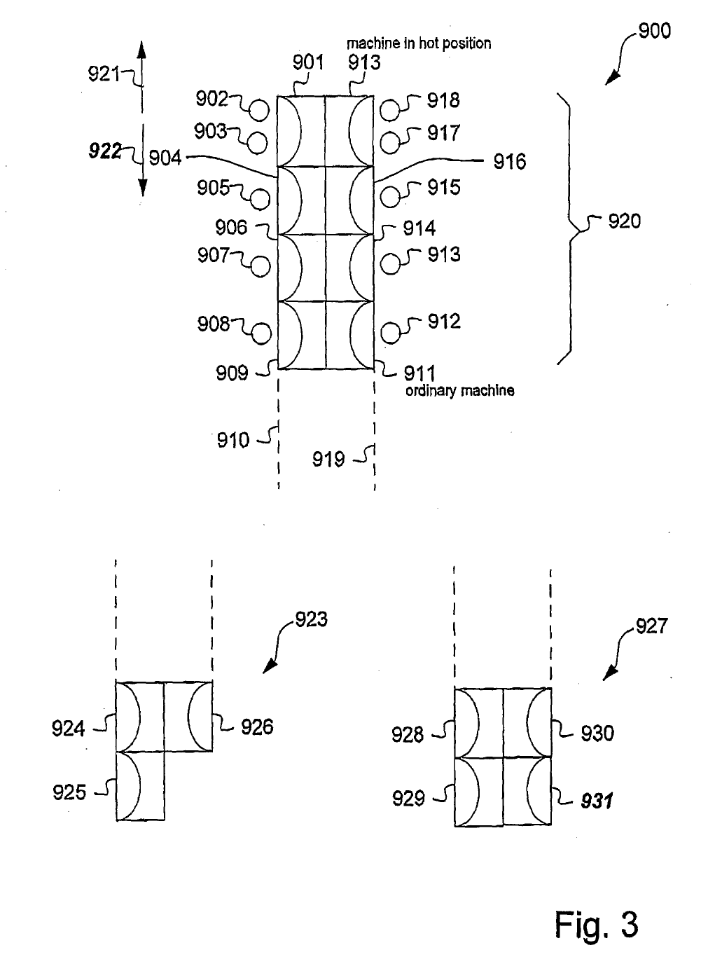

FIG. 3 depicts “ordinary” machines and machines in “hot” positions in a group 900 of gaming machines. Only a fragment 920 of the group 900 is shown, and dashed lines 910 and 919 indicate that the group 900 projects downwards towards the bottom of the page.

In the group fragment 920, game machines 904, 906, 909, 916, 914 and 911 are referred to as “ordinary” gaming machines. These ordinary gaming machines, being adjacent and parallel to other gaming machines, only afford playing room for a single patron at each machine. It is noted that the term “adjacent” allows for spacing between machines that are next to each other of 1 metre or less. Accordingly, the ordinary machine 909 accommodates, in comfort, a corresponding single patron 908. Similarly, the ordinary machine 916 accommodates, in comfort, a corresponding single patron 915. The ordinary machine 916 is said to have “immediately neighbouring machines” 914 and 913.

In contrast game machines 901 and 913 are referred to as machines in “hot” positions. These gaming machines in hot positions, lacking an immediately neighbouring machine on one side, afford playing room for two patrons at each machine. Accordingly, the machine in hot position 901 accommodates, in relative comfort, two corresponding patrons 902 and 903. Similarly, the machine in hot position 913 accommodates, in relative comfort, two corresponding patrons 917 and 918. If a single patron were to sit at the machine in hot position 901, then that patron would have an immediate neighbouring player sitting on their right hand side (ie in the direction of an arrow 922) however they would not have an immediate neighbouring player sitting on their left hand side (ie in the direction of an arrow 921).

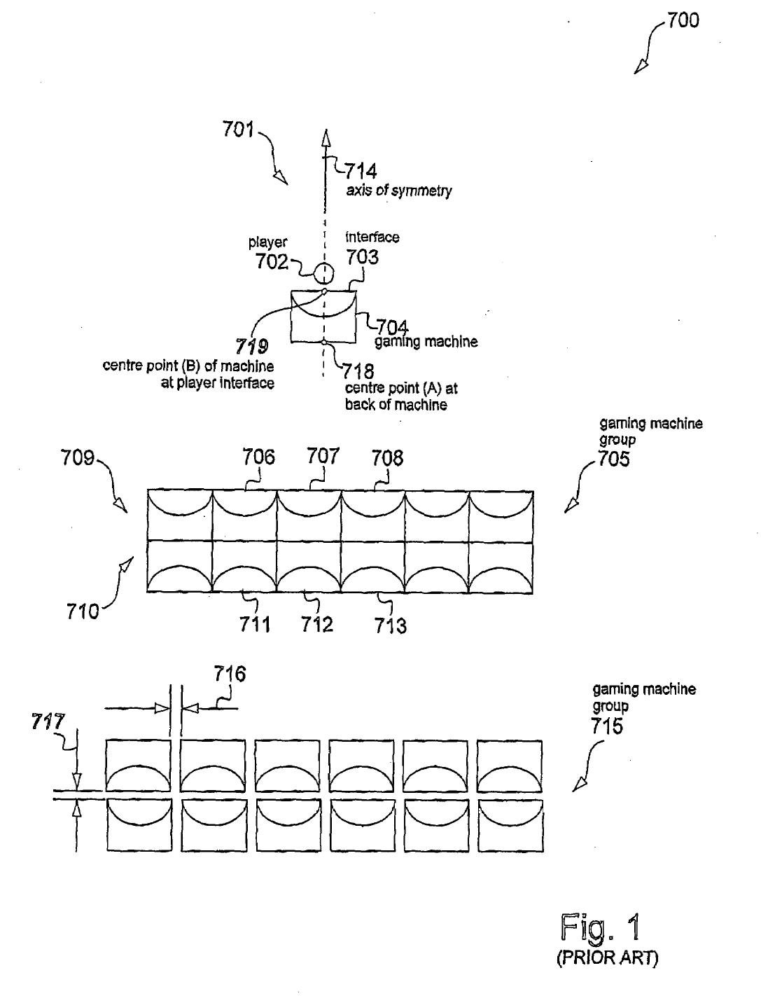

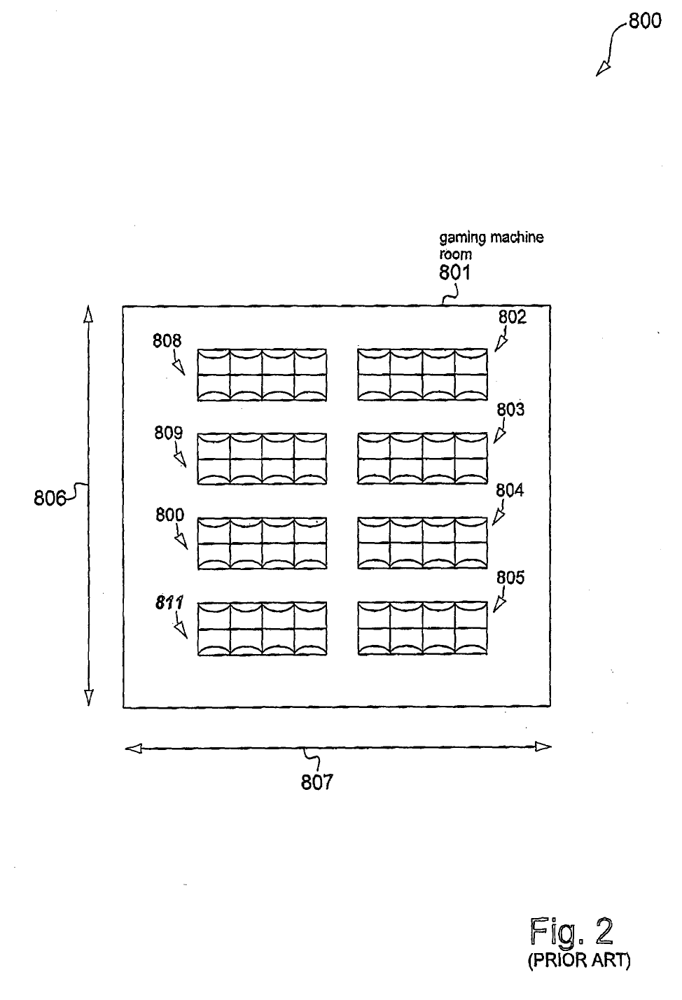

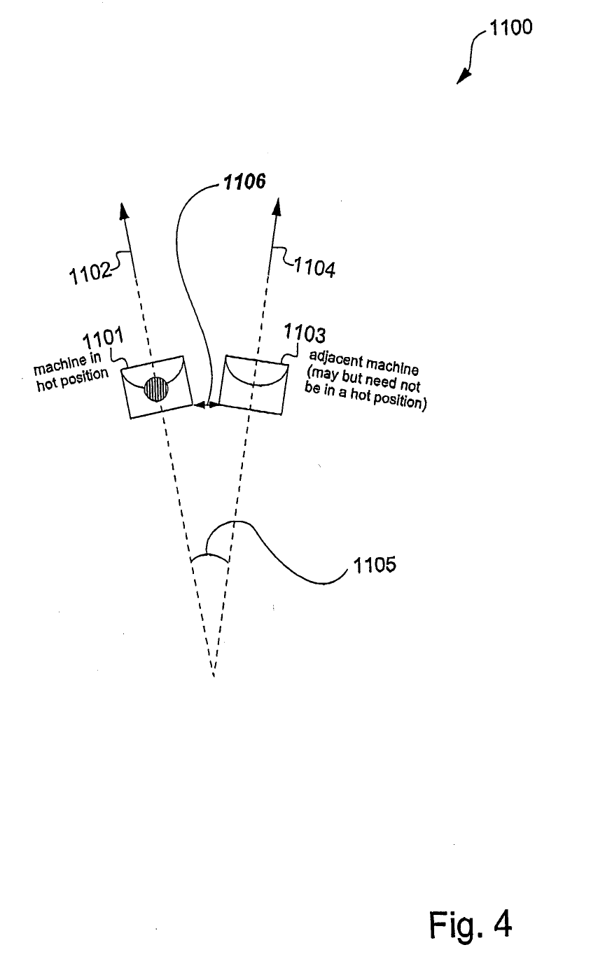

As described above, hot positions for gaming machines arise when a player at an immediately neighbouring machine would be present at most on one side of the hot position, thus affording playing room for two patrons at a machine in the hot position. A hot position can also arise if the axes of symmetry (see 714 in FIG. 1) of game machines in positions adjacent to the position in question diverge by more than 20 degrees from the axis of symmetry of the machine in question. Thus as depicted in FIG. 4, considering gaming machines 1101 and 1103, it is noted that at their point of closest approach, depicted by an arrow 1106, their distance from each other is one metre or less. Furthermore, the angular displacement between the axis of symmetry 1102 of the machine 1101, and the axis of symmetry 1104 of the machine 1103, is 20 degrees or more. A hot machine satisfies one or more of the aforementioned criteria.

In general, a group 900 of gaming machines arranged as depicted in FIG. 3 has two machines in hot positions at one end of the group 900 (eg the machines in hot positions 901 and 913 as shown), and another two machines in hot positions at the other end of the group 900. If the group 900 has an even number of gaming machines, as depicted by a group fragment 927, then gaming machines 928 and 930 are ordinary machines while gaming machines 929 and 931 are machines in hot positions. If the group 900 has an odd number of gaming machines, as depicted by a group fragment 923, then gaming machine 924 is an ordinary machine while gaming machines 925 and 926 are machines in hot positions.

Accordingly, given a group of N machines, arranged as depicted in FIG. 3, the group generally has 4 machines in hot positions and N-4 ordinary machines, Stated more generally, given a group of N machines, arranged as depicted in FIG. 3, the group according to the disclosed HPM method can have M machines in hot positions, where M is greater than 4 and less than or equal to N. It is noted that although this description considers the case in which the HPM approach provides a number of hot machines where M is greater than 4 and less than or equal to N, the method applies equally to cases where M is greater than another number greater than 4 and less than or equal to N.

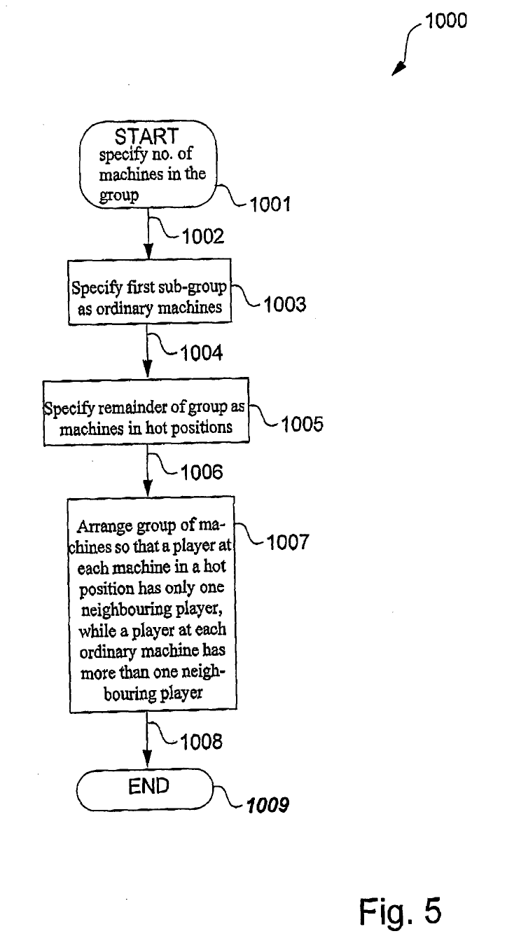

FIG. 5 shows a flow chart of an example 1000 of the HPM method for arranging a group of gaming machines. The method 1000 commences with a start step 1001 in which the number of gaming machines “N” in the group is specified, after which a step 1003 specifies a sub-group of the gaming machines as ordinary machines. A following step 1005 specifies the remainder of the gaming machines, being “M” of the total of “N” gaming machines, as machines in hot positions.

In an alternate arrangement, instead of defining the ordinary machines and the machines in hot positions in terms of the number of machines in each category (as done in the steps 1003 and 1005 in FIG. 5), the number of machines in hot positions can be specified in terms of a proportion (eg a percentage) of the total number of machines in the group, or as a proportion of the number of ordinary machines.

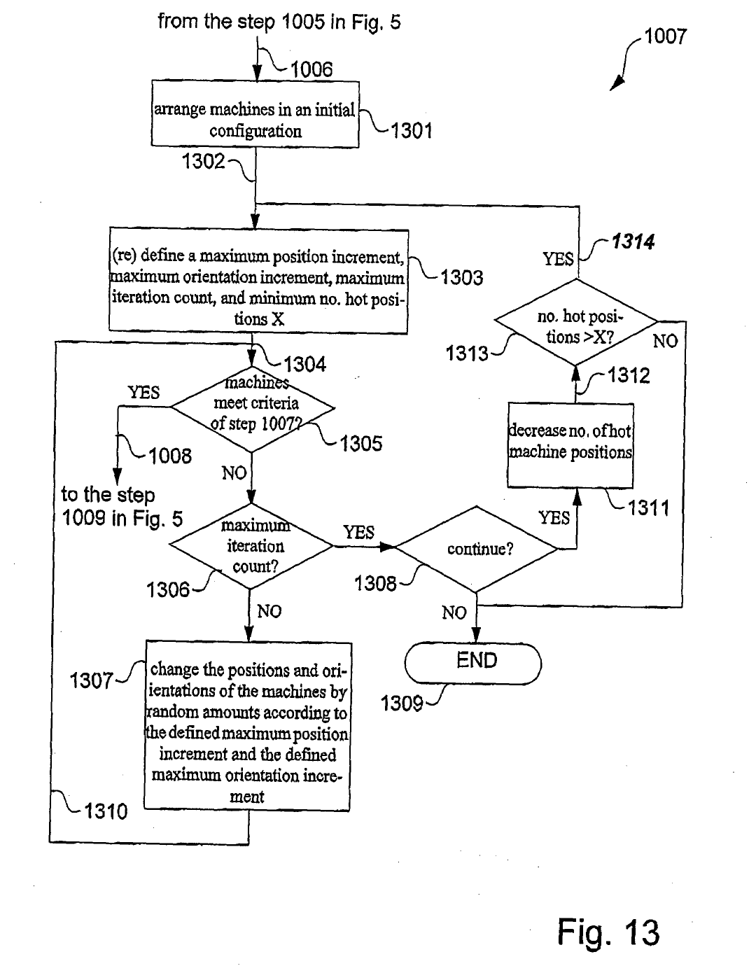

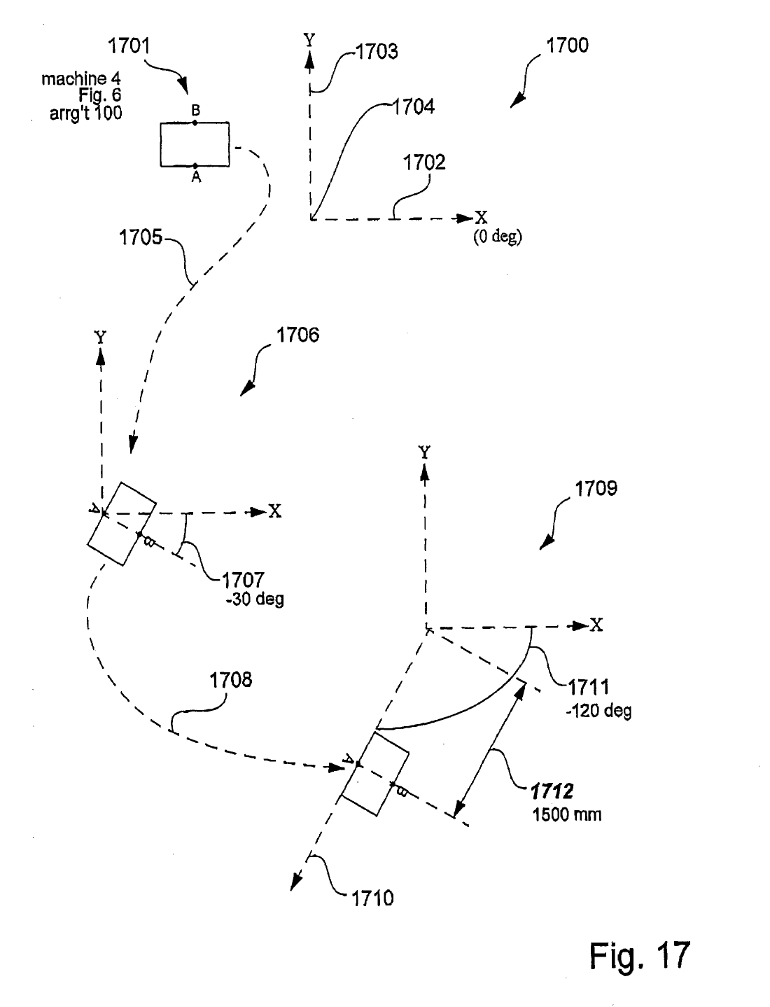

Thereafter, a step 1007 arranges, or places, the group of gaming machines so that a player at each designated machine in a hot position would have only one immediately neighbouring player, while a player at each ordinary machine would have more than one immediately neighbouring player. Alternately or in addition, the step 1007 arranges the machines in the group so that the axis of symmetry of a machine in a hot position in the group is angularly displaced from the axis of symmetry of an adjacent machine in the group by more than 20 degrees. One example of how the step 1007 can be performed is described in more detail in regard to FIG. 13. The method depicted in FIG. 5 produces information specifying the orientations and relative locations of the machines in a particular group (ie arrangement). Examples of this information is given in APPENDIX A in regard to a number of arrangements depicted in FIGS. 6-12 and 15-16. Further detail about how this information is used is given in regard to FIG. 17.

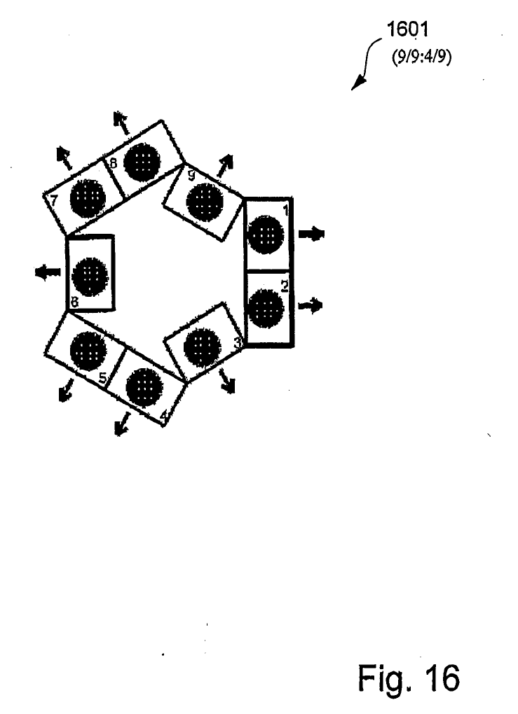

FIGS. 6-12 and 15-16 depict of examples of HPM arrangements. In each figure, machines marked with a [symbol] symbol are machines in hot positions. Each machine in each arrangement has an arrow indicating where the player would sit when operating the machine. Each arrangement such as 101 in FIG. 6, has next to the reference numeral (eg 101 in this case) a set of parameters such as (6/9; 4/9). This set of parameters means that the arrangement in question, namely 101 in this case, has 6 gaming machines in hot positions out of a total of 9 gaming machines, whereas a group of gaming machines arranged in the conventional manner depicted in FIG. 1 would have 4 gaming machines in hot positions out of a total of 9 gaming machines. Accordingly, the arrangement 101 has 6/4 ie 50% more machines in hot positions than would a group of nine gaming machines arranged in the conventional manner depicted in FIG. 1. Some of the arrangements have only a single set of parameters, such as 1602 in FIG. 16 which is characterised by parameters (3/3) meaning that all the machines are in hot positions.

FIG. 13 shows a flow chart of one example of how the arranging step 1007 in FIG. 5 can be performed. The entry into the process 1700 flows from the step 1005 in FIG. 5, after which a step 1301 arranges the gaming machines in an initial configuration. The initial configuration can, for example, be an arbitrary arrangement input by a person practicing the HPM arrangements.

In a following step 1303 the person defines (or re-defines if the process 1007 has already iterated at least once) a number of parameters. A “maximum position increment” is defined, this parameter placing a constraint on the distance that a gaming machine is allowed to be moved from its current position in any iteration. A “maximum orientation increment” is defined, this parameter placing a limit on the change in angular orientation that a gaming machine can be moved from its current orientation in any iteration. A “maximum iteration count” is defined, this parameter placing a limit on the number of iterations that can be performed (subject to the step 1308 as described below). Finally, a “minimum number of hot positions” is defined, this parameter “X” establishing the minimum on the number of hot positions that the person is prepared to accept. This reflects the fact that the person practicing the HPM arrangement may define an initial target number of hot positions, however if the method in FIGS. 5 and 13 fails to converge on a solution, then the person can lower the target and try again.

After the step 1303, a decision step 1305 determines whether the present configuration of gaming machines meets the criteria defined in FIG. 5 with respect to number of hot positions in the specified group. If this is the case, then the process 1007 follows a YES arrow from the step 1305 to the step 1009 in FIG. 5. Otherwise, the process 1007 follows a NO arrow from the step 1305 to a step 1306. The step 1306 determines if the maximum iteration count has been reached. If this is the case, then the process 1007 follows a YES arrow from the step 1306 to a step 1308. The step 1308 determines if the process 1007 is to continue. If this is the case, then the process 1007 follows a YES arrow from the step 1308 to a step 1311. The step 1311 decreases the number of hot positions defined in the step 1005 in FIG. 5. The decrement is typically one hot machine, however other decrements can be selected. A following step 1313 determines if the decremented number of hot positions is greater than the minimum number of hot positions defined in the step 1303. If this is the case then the process 1007 follows an arrow 1314 from the step 1313 back to the step 1303 in which the various parameters previously defined can be changed.

Returning to the step 1308, if the process is not to continue, then the process 1007 follows a NO arrow from the step 1308 to an END step 1309. Returning to the step 1313, if the decremented number of hot positions is not greater than the defined minimum number X, then the process 1007 follows a NO arrow from the step 1313 to the END step 1309.

Returning to the step 1306, if the maximum iteration count has not been reached, then the process 1007 follows a NO arrow from the step 1306 to a step 1307. The step 1307 changes the positions and orientations of at least some of the gaming machines in the group subject to the constraints imposed in the step 1303. The process then follows an arrow 1310 back to the step 1305.

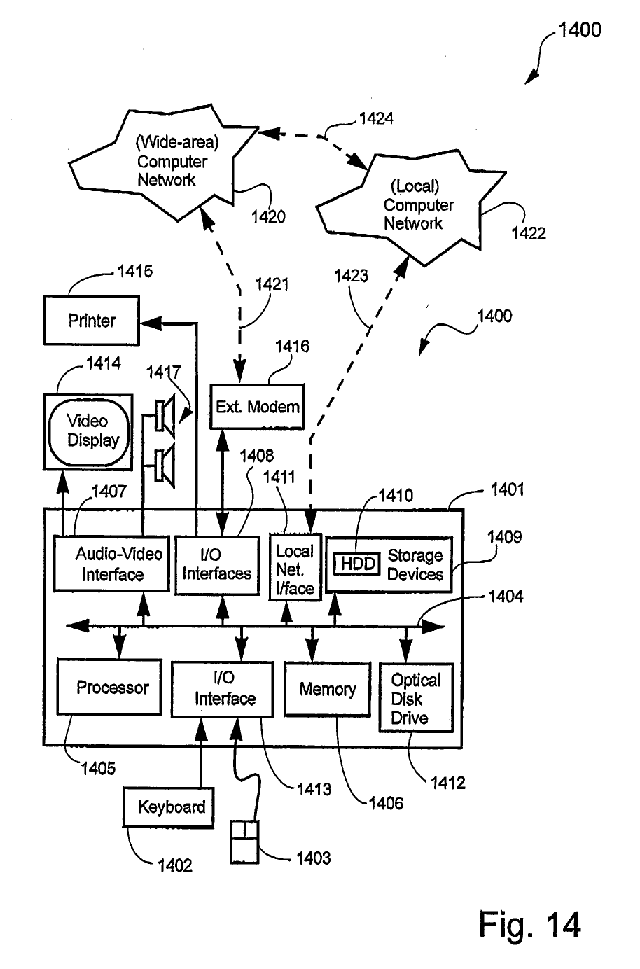

FIG. 14 is a schematic block diagram of a general-purpose computer upon which HPM arrangements can be practiced. The HPM method may be implemented using a computer system 1400, such as that shown in FIG. 14 wherein the processes of FIGS. 5 and 13 may be implemented as software, such as one or more application programs executable within the computer system 1400. In particular, the steps of the RPM method are effected by instructions in the software that are carried out within the computer system 1400. The instructions may be formed as one or more code modules, each for performing one or more particular tasks. The software may also be divided into two separate parts, in which a first part and the corresponding code modules performs the HPM methods and a second part and the corresponding code modules manage a user interface between the first part and the user.

The software may be stored in a computer readable medium, including the storage devices described below, for example. The software is loaded into the computer system 1400 from the computer readable medium, and then executed by the computer system 1400. A computer readable medium having such software or computer program recorded on it is a computer program product. The use of the computer program product in the computer system 1400 preferably effects an advantageous apparatus for performing the HPM method.

As seen in FIG. 14, the computer system 1400 is formed by a computer module 1401, input devices such as a keyboard 1402 and a mouse pointer device 1403, and output devices including a printer 1415, a display device 1414 and loudspeakers 1417. An external Modulator-Demodulator (Modem) transceiver device 1416 may be used by the computer module 1401 for communicating to and from a communications network 1420 via a connection 1421. The network 1420 may be a wide-area network (WAN), such as the Internet or a private WAN. Where the connection 1421 is a telephone line, the modem 1416 may be a traditional “dial-up” modem. Alternatively, where the connection 1421 is a high capacity (eg: cable) connection, the modem 1416 may be a broadband modem. A wireless modem may also be used for wireless connection to the network 1420.

The computer module 1401 typically includes at least one processor unit 1405, and a memory unit 1406 for example formed from semiconductor random access memory (RAM) and read only memory (ROM). The module 1401 also includes an number of input/output (I/O) interfaces including an audio-video interface 1407 that couples to the video display 1414 and loudspeakers 1417, an I/O interface 1413 for the keyboard 1402 and mouse 1403 and optionally a joystick (not illustrated), and an interface 1408 for the external modem 1416 and printer 1415. In some implementations, the modem 1416 may be incorporated within the computer module 1401, for example with the interface 1408.

The computer module 1401 also has a local network interface 1411 which, via a connection 1423, permits coupling of the computer system 1400 to a local computer network 1422, known as a Local Area Network (LAN). As also illustrated, the local network 1422 may also couple to the wide network 1420 via a connection 1424, which would typically include a so-called “firewall” device or similar functionality. The interface 1411 may be formed by an Ethernet™ circuit card, a wireless Bluetooth™ or an IEEE 802.21 wireless arrangement.

The interfaces 1408 and 1413 may afford both serial and parallel connectivity, the former typically being implemented according to the Universal Serial Bus (USB) standards and having corresponding USB connectors (not illustrated). Storage devices 1409 are provided and typically include a hard disk drive (HDD) 1410. Other devices such as a floppy disk drive and a magnetic tape drive (not illustrated) may also be used. An optical disk drive 1412 is typically provided to act as a non-volatile source of data. Portable memory devices, such optical disks (eg: CD-ROM, DVD), USB-RAM, and floppy disks for example may then be used as appropriate sources of data to the system 1400.

The components 1405, to 1413 of the computer module 1401 typically communicate via an interconnected bus 1404 and in a manner which results in a conventional mode of operation of the computer system 1400 known to those in the relevant art. Examples of computers on which the described arrangements can be practised include IBM-PC's and compatibles, Sun Sparcstations, Apple Mac™ or alike computer systems evolved therefrom.

Typically, the application programs discussed above are resident on the hard disk drive 1410 and read and controlled in execution by the processor 1405. Intermediate storage of such programs and any data fetched from the networks 1420 and 1422 may be accomplished using the semiconductor memory 1406, possibly in concert with the hard disk drive 1410. In some instances, the application programs may be supplied to the user encoded on one or more CD-ROM and read via the corresponding drive 1412, or alternatively may be read by the user from the networks 1420 or 1422.

Still further, the software can also be loaded into the computer system 1400 from other computer readable media. Computer readable media refers to any storage or transmission medium that participates in providing instructions and/or data to the computer system 1400 for execution and/or processing. Examples of such storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 1401. Examples of computer readable transmission media that may also participate in the provision of instructions and/or data include radio or infra-red transmission channels as well as a network connection to another computer or networked device, and the Internet or Intranets including e-mail transmissions and information recorded on Websites and the like.

The second part of the application programs and the corresponding code modules mentioned above may be executed to implement one or more graphical user interfaces (GUIs) to be rendered or otherwise represented upon the display 1414. Through manipulation of the keyboard 1402 and the mouse 1403, a user of the computer system 1400 and the application may manipulate the interface to provide controlling commands and/or input to the applications associated with the GUI(s).

FIG. 17 illustrates how the information in APPENDIX A can be used to position machines in a group whose geometry has been determined according to the HPM method.

FIG. 17 shows a set 1700 of perpendicular axes with an X axis 1702, a Y axis 1703 and an origin 1704. The X axis 1702 is defined to have an orientation of “0” degrees. Also shown is a depiction 1701 of the machine number 4 from FIG. 6. This machine has a centre point at the player interface depicted by a point “B” and a centre point at the back of the machine depicted by a point “A” as described in relation to FIG. 1. FIG. 17 relates specifically to the information in APPENDIX A which defines the orientations and relative positions of the machines in the group 106 of machines in FIG. 6. However, the approach shown in FIG. 17 applies equally to other groups of machines arranged according to the disclosed HPM approach.

The machines in the group 100 in FIG. 6 have associated numbers 1-9 and the following description relates to machine number 4 which has a reference numeral 108.

The table in APPENDIX A is made up of table sections, each of which has a row at the top of the section with a figure number. Thus, for example, the very top row of the table contains the designation “FIG. 6” and the following 10 rows relate to FIG. 6, and in particular to arrangement 100 in FIG. 6. The next row also contains the designation “FIG. 6” and the following 7 rows relate to FIG. 6, and in particular to arrangement 107 in FIG. 6.

The fourth row in the table in APPENDIX A in the table section relating to FIG. 6 arrangement 100 has four columns the first of which contains the data “100:4” indicating that this row of information relates to machine number 4 in arrangement 100.

The next column in row 4 contains the data “B @ −30 deg”. This means that the machine 1701 in FIG. 17 is positioned, as depicted by a dashed arrow 1705, with “A” at the origin, and the dashed line “A”-“B” describing an angle of −30 degrees (1707) to the X axis as shown in a view 1706.

The fourth column of row 4 contains the data “−120 deg”. This means, as shown in a view 1709, that a dashed line 1710 is drawn from the origin at an angle of −120 degrees to the X axis as depicted by a reference numeral 1711.

The third column of row 4 contains the data “D=1590 mm”. This means, as depicted by a dashed arrow 1708, that the machine is slid along the line 1710, maintaining the angular orientation established in the view 1706, until the point “A” is 1590 mm from the origin of the axes, as depicted by a reference numeral 1712.

This approach is used, in regard to the group 100 in FIG. 6, in regard to the other machines 1-3 and 5-9, which results in the group of machines arranged as shown at 100 in FIG. 6. It is noted that the angular orientations in columns 2 and 4 of the table sections in APPENDIX A can vary by +/−15 degrees, and the distances in column 3 of the tables can vary by +/−300 mm according to the HPM method.

### INDUSTRIAL APPLICABILITY

It is apparent from the above that the arrangements described are applicable to the gaming, casino, club and hospitality industries.

The foregoing describes only some embodiments of the present invention, and modifications and/or changes can be made thereto without departing from the scope and spirit of the invention, the embodiments being illustrative and not restrictive.

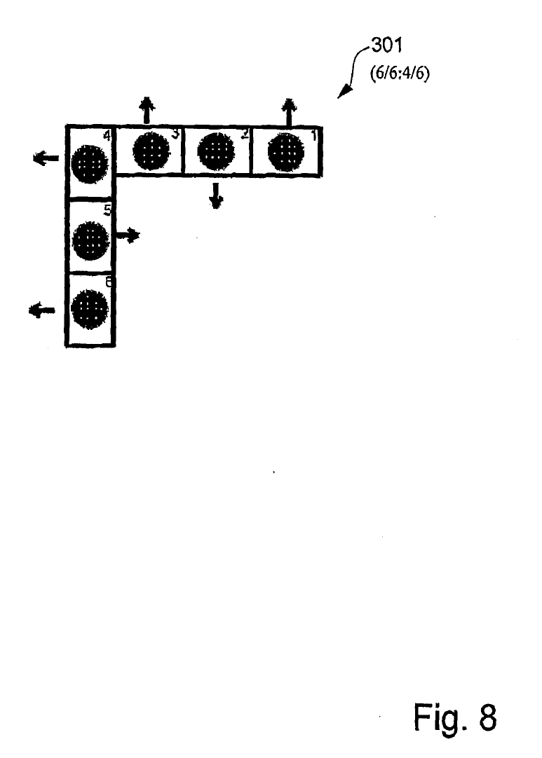

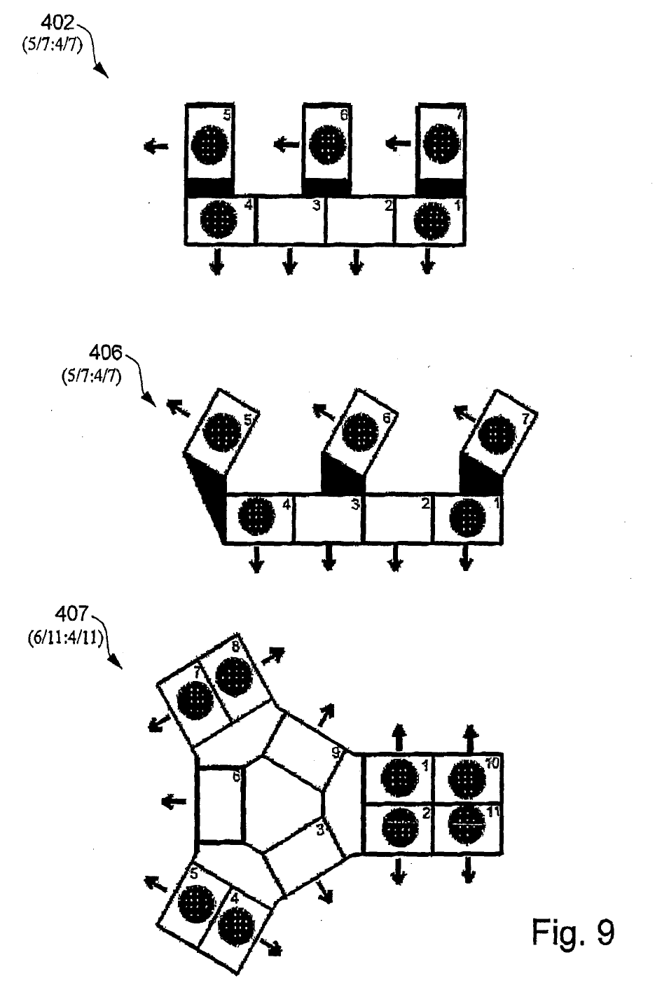

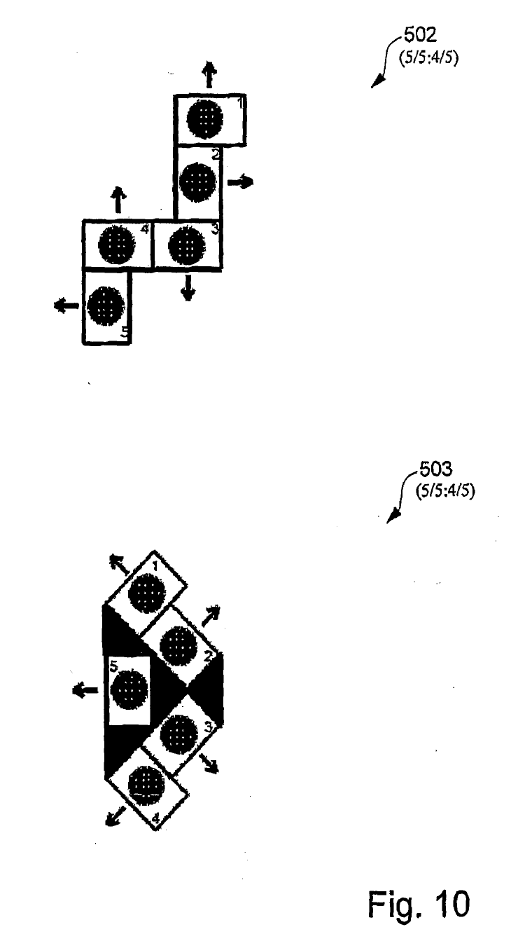

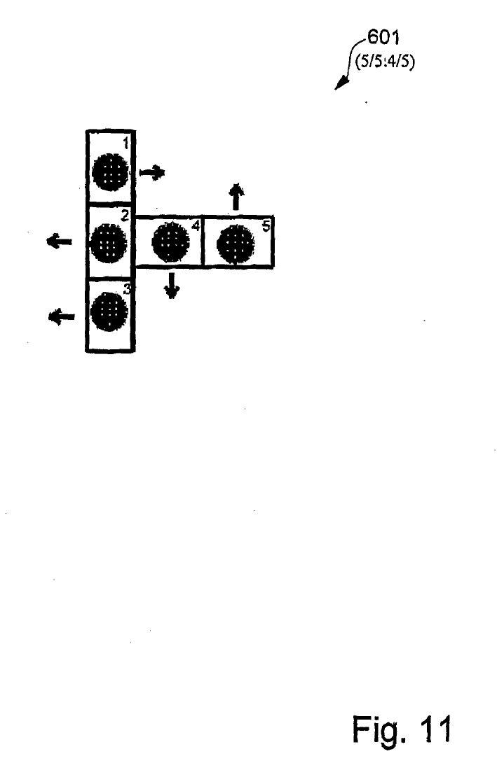

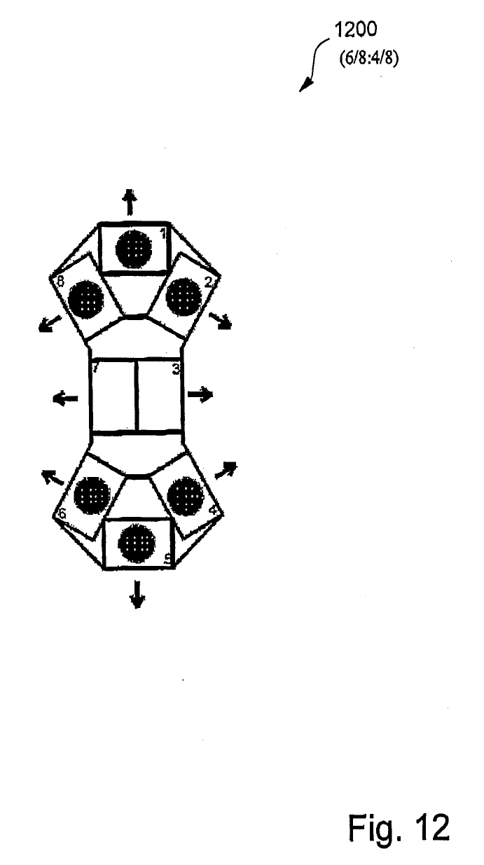

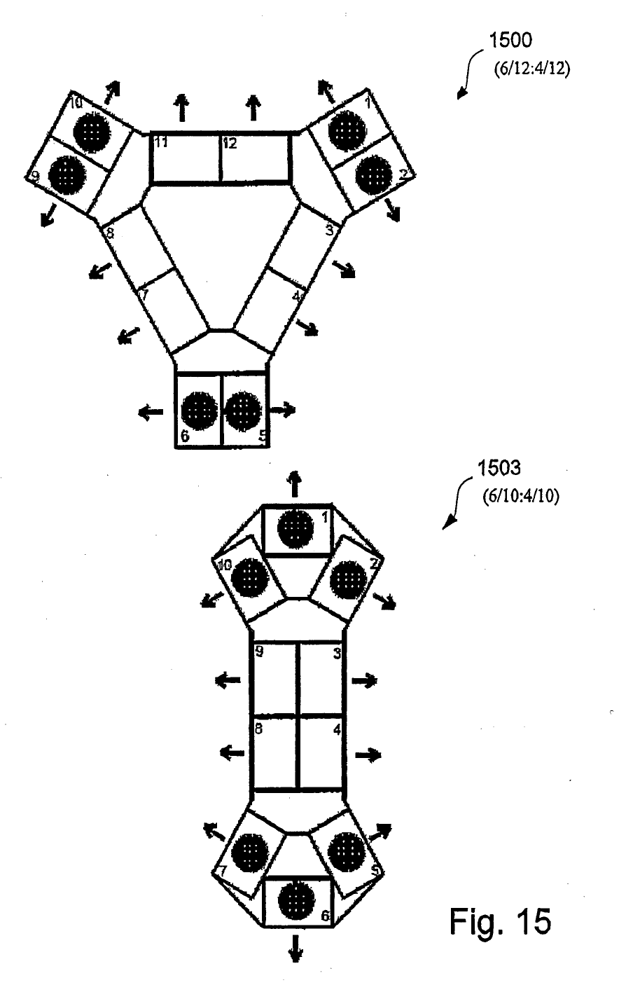

APPENDIX A

| | STEP 1: ORIENTATION OF MACHINE | STEP 2: DISTANCE OF | | |
|---|---|---|---|---|
| | WITH REF POINT (A) FIXED AT | PLACEMENT | STEP 3: BEARING OF MACHINE | |
| ARRANGEMENT/ | ORIGIN (O) | MOVE MACHINE REF (A) | ANGLE OF MACHINE REF AT | |
| MACHINE | ANGLE OF REF POINT (B) | THE DISTANCE (D) | POINT (A) TO ORIGIN (O) FROM | |
| REF | IN RELATION TO (X) AXIS | OF ORIGIN (O) | (X) AXIS | |
| FIG. 6 | | | | |
| 100:1 | B @ 90 deg | D = 1590 mm | 0 | deg |
| 100:2 | B @ −90 deg | D = 1590 mm | 0 | deg |
| 100:3 | B @ −60 deg | D = 270 mm | −60 | deg |
| 100:4 | B @ −30 deg | D = 1590 mm | −120 | deg |
| 100:5 | B @ 150 deg | D = 1590 mm | −120 | deg |
| 100:6 | B @ 180 deg | D = 270 mm | 180 | deg |
| 100:7 | B @ −150 deg | D = 1590 mm | 120 | deg |
| 100:8 | B @ 30 deg | D = 1590 mm | 120 | deg |
| 100:9 | B @ 60 deg | D = 270 mm | 60 | deg |
| 107:1 | B @ 90 deg | D = 450 mm | 0 | deg |
| 107:2 | B @ 162 deg | D = 1040 mm | 83 | deg |
| 107:3 | B @ −126 deg | D = 1418 mm | 132 | deg |
| 107:4 | B @ −54 deg | D = 1300 mm | 178 | deg |
| 107:5 | B @ 18 deg | D = 125 mm | −125 | deg |
| FIG. 8 | | | | |
| 301:1 | B @ 90 deg | D = 2250 mm | 0 | deg |
| 301:2 | B @ −90 deg | D = 1479 mm | 24 | deg |
| 301:3 | B @ 90 deg | D = 450 mm | 0 | deg |
| 301:4 | B @ 180 deg | D = 150 mm | 90 | deg |
| 301:5 | B @ 0 deg | D = 960 mm | −128 | deg |
| 301:6 | B @ 180 deg | D = 1650 mm | −90 | deg |
| FIG. 9 | | | | |
| 402:1 | B @ −90 deg | D = 450 mm | 180 | deg |
| 402:2 | B @ −90 deg | D = 1350 mm | 180 | deg |
| 402:3 | B @ −90 deg | D = 2250 mm | 180 | deg |
| 402:4 | B @ −90 deg | D = 3150 mm | 180 | deg |
| 402:5 | B @ 180 deg | D = 3070 mm | 168 | deg |
| 402:6 | B @ 180 deg | D = 1625 mm | 156 | deg |
| 402:7 | B @ 180 deg | D = 650 mm | 90 | deg |
| 406:1 | B @ −90 deg | D = 1350 mm | 0 | deg |
| 406:2 | B @ −90 deg | D = 450 mm | 0 | deg |
| 406:3 | B @ −90 deg | D = 450 mm | 180 | deg |
| 406:4 | B @ −90 deg | D = 1350 mm | 180 | deg |
| 406:5 | B @ 150 deg | D = 1682 mm | 160 | deg |
| 406:6 | B @ 150 deg | D = 631 mm | 69 | deg |
| 406:7 | B @ 150 deg | D = 2111 mm | 16 | deg |
| 407:1 | B @ 90 deg | D = 1590 mm | 0 | deg |
| 407:2 | B @ −90 deg | D = 1590 mm | 0 | deg |
| 407:3 | B @ −60 deg | D = 270 mm | −60 | deg |
| 407:4 | B @ −30 deg | D = 1590 mm | −120 | deg |
| 407:5 | B @ 150 deg | D = 1590 mm | −120 | deg |
| 407:6 | B @ 180 deg | D = 270 mm | 180 | deg |
| 407:7 | B @ −150 deg | D = 1590 mm | 120 | deg |
| 407:8 | B @ 30 deg | D = 1590 mm | 120 | deg |
| 407:9 | B @ 60 deg | D = 270 mm | 60 | deg |
| 407:10 | B @ 90 deg | D = 2490 mm | 0 | deg |
| 407:11 | B @ −90 deg | D = 2490 mm | 0 | deg |
| FIG. 10 | | | | |
| 502:1 | B @ 90 deg | D = 450 mm | 0 | deg |
| 502:2 | B @ 0 deg | D = 450 mm | −90 | deg |
| 502:3 | B @ −90 deg | D = 912 mm | −80 | deg |
| 502:4 | B @ 90 deg | D = 1678 mm | −117 | deg |
| 502:5 | B @ 180 deg | D = 2041 mm | −107 | deg |
| 503:1 | B @ 135 deg | D = 1005 mm | 108 | deg |
| 503:2 | B @ 45 deg | D = 450 mm | 135 | deg |
| 503:3 | B @ −45 deg | D = 450 mm | −135 | deg |
| 503:4 | B @ −135 deg | D = 1005 mm | −108 | deg |
| 503:5 | B @ 180 deg | D = 450 mm | 180 | deg |
| Fig. 11 | | | | |
| 601:1 | B @ 0 deg | D = 1090 mm | 123 | deg |
| 601:2 | B @ 180 deg | D = 0 mm | 180 | deg |
| 601:3 | B @ 180 deg | D = 900 mm | −90 | deg |
| 601:4 | B @ −90 deg | D = 545 mm | 33 | deg |
| 601:5 | B @ 90 deg | D = 1388 mm | −12.5 | deg |
| FIG. 12 | | | | |
| 1200:1 | B @ 90 deg | D = 1515 mm | 90 | deg |
| 1200:2 | B @ −30 deg | D = 1421 mm | 75 | deg |
| 1200:3 | B @ 0 deg | D = 0 mm | 0 | deg |
| 1200:4 | B @ 30 deg | D = 1421 mm | −75 | deg |
| 1200:5 | B @ −90 deg | D = 1515 mm | −90 | deg |
| 1200:6 | B @ 150 deg | D = 1421 mm | −105 | deg |
| 1200:7 | B @ 180 deg | D = 0 mm | 180 | deg |
| 1200:8 | B @ −150 deg | D = 1421 mm | 105 | deg |
| FIG. 15 | | | | |
| 1500:1 | B @ 120 deg | D = 2105 mm | 30 | deg |
| 1500:2 | B @ −60 deg | D = 2105 mm | 30 | deg |
| 1500:3 | B @ −30 deg | D = 820 mm | 3.5 | deg |
| 1500:4 | B @ −30 deg | D = 820 mm | −63 | deg |
| 1500:5 | B @ 0 deg | D = 2105 mm | −90 | deg |
| 1500:6 | B @ 180 deg | D = 2105 mm | −90 | deg |
| 1500:7 | B @ −150 deg | D = 820 mm | −117 | deg |
| 1500:8 | B @ −150 deg | D = 820 mm | −3.5 | deg |
| 1500:9 | B @ −120 deg | D = 2105 mm | 150 | deg |
| 1500:10 | B @ 60 deg | D = 2105 mm | 150 | deg |
| 1500:11 | B @ 90 deg | D = 820 mm | 123 | deg |
| 1500:12 | B @ 90 deg | D = 820 mm | 57 | deg |
| 1503:1 | B @ 90 deg | D = 1965 mm | 90 | deg |
| 1503:2 | B @ −30 deg | D = 1860 mm | 79 | deg |
| 1503:3 | B @ 0 deg | D = 450 mm | 90 | deg |
| 1503:4 | B @ 0 deg | D = 450 mm | −90 | deg |
| 1503:5 | B @ 30 deg | D = 1860 mm | −79 | deg |
| 1503:6 | B @ −90 deg | D = 1965 mm | −90 | deg |
| 1503:7 | B @ 150 deg | D = 1860 mm | −101 | deg |
| 1503:8 | B @ 180 deg | D = 450 mm | −90 | deg |
| 1503:9 | B @ 180 deg | D = 450 mm | 90 | deg |
| 1503:10 | B @ −150 deg | D = 1860 mm | 101 | deg |
| FIG. 16 | | | | |
| 1601:1 | B @ 0 deg | D = 1133 mm | 23 | deg |
| 1601:2 | B @ 0 deg | D = 1133 mm | −23 | deg |
| 1601:3 | B @ −60 deg | D = 1739 mm | −60 | deg |
| 1601:4 | B @ −120 deg | D = 1132 mm | −97 | deg |
| 1601:5 | B @ −120 deg | D = 1132 mm | −143 | deg |
| 1601:6 | B @ 180 deg | D = 698 mm | 180 | deg |
| 1601:7 | B @ 120 deg | D = 1132 mm | 143 | deg |
| 1601:8 | B @ 120 deg | D = 1132 mm | 97 | deg |
| 1601:9 | B @ 60 deg | D = 701 mm | 60 | deg |

1. A method of arranging a group of adjacent gaming machines in a restricted space, each said machine being, at a point of closest approach, a distance of one metre or less from a neighbouring machine in the group, the method comprising the steps of:
specifying the number of gaming machines in the group;
specifying a sub-set of the machines to be ordinary machines;
specifying the remainder of the machines to be hot machines wherein the number of hot machines in the group exceeds a predetermined number; and
arranging the plurality of gaming machines so that in regard to hot machines in the group, at least one of the following criteria are met:
a said hot machine lacks an immediately neighbouring machine on at least one side; and
a player at a hot machine does not have an immediate neighbouring player on at least one side.

2. A method according to claim 1, wherein the arranging step comprises the steps of:
(a) placing the group of machines in an initial arrangement;
(b) setting constraints on allowable changes in position and orientation of the machines, maximum number of iterations and minimum number of hot machines;
(c) determining if the criteria are met;
(d) if the criteria are not met, changing at least one of the position and the orientation of at least some of the machines in the group subject to said constraints; and
(e) repeating the determining step.

3. A method according to claim 2, comprising the further steps of:
if the number of times the repeating step is performed is equal to the maximum number of iterations, reducing the specified number of hot machines; and
repeating the steps (b) to (e).

4. A method according to claim 1, wherein the predetermined number is equal to 5.

5. An apparatus for arranging a group of adjacent gaming machines in a restricted space, each said machine being, at a point of closest approach, a distance of one metre or less from a neighbouring machine in the group, said apparatus comprising:
a memory for storing a program; and
a processor for executing the program, said program comprising:
code for specifying the number of gaming machines in the group;
code for specifying a sub-set of the machines to be ordinary machines;
code for specifying the remainder of the machines to be hot machines wherein the number of hot machines in the group exceeds a predetermined number; and
code for arranging the plurality of gaming machines so that in regard to hot machines in the group, at least one of the following criteria are met:
a said hot machine lacks an immediately neighbouring machine on at least one side; and
a player at a hot machine does not have an immediate neighbouring player on at least one side,

6. An apparatus according to claim 5, wherein the predetermined number is equal to 5.

7. A computer program product including a computer readable medium having recorded thereon a computer program for directing a processor to execute a method for arranging a group of adjacent gaming machines in a restricted space, each said machine being, at a point of closest approach, a distance of one metre or less from a neighbouring machine in the group, said program comprising:
code for specifying the number of gaming machines in the group;
code for specifying a sub-set of the machines to be ordinary machines;
code for specifying the remainder of the machines to be hot machines wherein the number of hot machines in the group exceeds a predetermined number; and
code for arranging the plurality of gaming machines so that in regard to hot machines in the group, at least one of the following criteria are met:
a said hot machine lacks an immediately neighbouring machine on at least one side; and
a player at a hot machine does not have an immediate neighbouring player on at least one side.

8. A computer program product according to claim 7, wherein the predetermined number is 5.

9. An arrangement of a group of adjacent gaming machines in a restricted space, wherein:
adjacent gaming machines in the group are, at their point of closest approach, at a distance of one metre or less;
a sub-set of the machines are ordinary machines;
the remainder of the machines are hot machines;
the number of hot machines in the group is greater than a predetermined number; and wherein in regard to hot machines in the group at least one of the following criteria are met:
a said hot machine lacks an immediately neighbouring machine on at least one side; and
a player at a hot machine does not have an immediate neighbouring player on at least one side.

10. An arrangement of a group of adjacent gaming machines according to claim 9, wherein the predetermined number is 5.

11. An arrangement of a group of adjacent gaming machines according to claim 10, wherein the orientations and relative locations of the gaming machines are defined by any one of APPENDICES A-H.
